(19) United States
(12) Patent Application Publication
(10) Pub. No.: US 2024/0375662 A1
(43) Pub. Date: Nov. 14, 2024

(54) VEHICLE CONTROL DEVICE

(71) Applicant: TOYOTA JIDOSHA KABUSHIKI KAISHA, Toyota-shi (JP)

(72) Inventors: Haruki Oguri, Toyota-shi (JP); Kenichi Yamada, Nisshin-shi (JP); Hirohito Ide, Nagoya-shi (JP)

(73) Assignee: TOYOTA JIDOSHA KABUSHIKI KAISHA, Toyota-shi (JP)

(21) Appl. No.: 18/421,455

(22) Filed: Jan. 24, 2024

(30) Foreign Application Priority Data
May 9, 2023 (JP) 2023-077120

(51) Int. Cl. B60W 30/182; B60W 50/00; B60W 50/08; B60W 50/10; B60W 60/00

(52) U.S. Cl. CPC B60W 30/182; B60W 50/082; B60W 50/10; B60W 60/005; B60W 2050/007

(57) ABSTRACT

A vehicle control device is a vehicle control device that is connected between an automated driving system and a vehicle platform that performs automated driving according to commands from the automated driving system, and includes: a memory that stores a program and a memory that executes the program; and a processor that interfaces between the autonomous driving system and the vehicle platform. When the processor receives a manual startup command in the unknown state, it transitions to the pure manual state, and when it receives a startup command from the automated driving system in the unknown state, it transitions to the pre-standby state, and in the pre-standby state, it transitions to standby mode. When the transition conditions are met, the system transitions to standby mode, and when the driver's driving intention is detected in the pre-standby state, the system transitions to pure manual state.

### CROSS-REFERENCE TO RELATED APPLICATION

This application claims priority to Japanese Patent Application No. 2023-077120 filed on May 9, 2023, incorporated herein by reference in its entirety.

### BACKGROUND

### 1. Technical Field

This disclosure relates to a vehicle control device, and particularly to a vehicle control device connected between an automated driving system and a vehicle platform that performs automated driving according to instructions from the automated driving system.

### 2. Description of Related Art

In recent years, the development of automated driving technology for vehicles has been progressing. For example, in a vehicle control system disclosed in Japanese Unexamined Patent Application Publication No. 2019-177807 (JP 2019-177807 A), a vehicle and an information processing device cooperate to execute automated driving. The information processing device automatically generates control information using automated driving control software, and transmits the generated control information to the vehicle. The vehicle performs automated driving based on the received control information.

### SUMMARY

It is conceivable to attach an automated driving system externally to a vehicle body (vehicle platform described later). Automated driving is achieved by the vehicle platform controlling the vehicle according to instructions from the automated driving system. The vehicle platform has, as vehicle modes, a manual driving mode in which the vehicle is under the control of the driver, an automated driving mode in which the vehicle is under the control of the automated driving system, and a standby mode in which the vehicle is basically uncontrollable by the driver and waits for the start of control by the automated driving system.

When this vehicle is used for a service to transport passengers, it is considered that the vehicle is usually operated through automated driving. When a transition is not made from the manual driving mode to the standby mode for some reason soon after the automated driving system starts up the vehicle platform, an operator of the vehicle may assume that the vehicle is in the manual driving mode since automated driving is not started, and may start manual driving. If the shift range is not the parking range when a condition for a transition to the standby mode is met and a transition is made to the standby mode after the start of manual driving, a transition is not made to the automated driving mode, even if an instruction to transition to the automated driving mode is transmitted from the automated driving system. If the shift range is switched to the parking range in this situation, the vehicle may become immobile since an operation by the operator to switch to a different shift range is not received as the vehicle is in the standby mode, and an instruction from the automated driving system is also not received as a transition has not been made to the automated driving mode.

This disclosure has been made in order to address the above-mentioned issue, and the purpose is to provide a vehicle control device capable of avoiding a vehicle becoming immobile when automated driving is started.

An aspect of this disclosure provides
a vehicle control device connected between an automated driving system and a vehicle platform that performs automated driving according to instructions from the automated driving system. The vehicle control device includes:
a memory that stores a program that includes a predetermined application program interface (API) defined for each signal; and
a processor that interfaces between the automated driving system and the vehicle platform by executing the program.
   The vehicle control device includes a manual driving mode, an automated driving mode, and a standby mode as vehicle modes.
   The manual driving mode includes an unknown state, a pure manual state, and a pre-standby state.
   The vehicle platform is able to
receive manual driving operations in the manual driving mode, receive an operation of shifting a shift range to a parking range, among the manual driving operations, in the standby mode, and
receive a driving instruction from the automated driving system in the automated driving mode.
   The processor is configured to transition to the pure manual state on condition that a startup instruction by a manual operation is received in the unknown state,
transition to the pre-standby state on condition that a startup instruction is received from the automated driving system in the unknown state,
transition to the standby mode on condition that a condition for transitioning to the standby mode is met in the pre-standby state, and
transition to the pure manual state on condition that an intention of a driver to drive is detected in the pre-standby state.

According to such a configuration, a transition is made to the pre-standby state on condition that a startup instruction is received from the automated driving system in the unknown state, and a transition is made to the pure manual state on condition that the intention of the driver to drive is detected in the pre-standby state. Therefore, a transition cannot be made to the standby mode when the intention to drive is detected before a transition is made to the standby mode. As a result, it is possible to provide a vehicle control device capable of avoiding a vehicle becoming immobile when automated driving is started.

The processor may be configured to: transition to the automated driving mode on condition that an automated driving transition instruction is received from the automated driving system in the standby mode and that the shift range is the parking range; and transition to an error state on condition that the automated driving transition instruction is received from the automated driving system in the standby mode and the shift range is not the parking range.

According to such a configuration, it is possible to avoid an undesirable situation in which automated driving is started when the shift range is not the parking range in the standby mode.

The processor may be configured to transition to the automated driving mode on condition that an automated driving transition instruction is received in the pure manual state.

According to such a configuration, it is possible to make a transition from a state in which manual driving is enabled to a state in which automated driving is enabled.

The processor may be configured to transition to the pure manual state on condition that a standby mode stop instruction is received from the automated driving system in the standby mode.

According to such a configuration, manual driving can be enabled with a stop instruction from the automated driving system, even when a transition is made to the standby mode.

The processor may be configured to transition to the pure manual state on condition that an automated driving stop instruction is received from the automated driving system in the automated driving mode.

According to such a configuration, manual driving can be enabled with a stop instruction from the automated driving system, even when a transition is made to the automated driving mode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an overview of a vehicle according to an embodiment of this disclosure;

FIG. 2 is a diagram showing the configuration of ADK, VCIB, and VP in more detail;

FIG. 3 is a state transition diagram for explaining vehicle modes in this embodiment;

FIG. 4 is a time chart for explaining the transition from the unknown state to the pre-standby state in the manual operation mode;

FIG. 5 is a time chart for explaining the transition from the pre-standby state to the standby mode in the manual operation mode; and

FIG. 6 is a time chart for explaining the transition from the unknown state of the manual mode to the pre-standby state and then to the pure manual state.

### DETAILED DESCRIPTION OF EMBODIMENTS

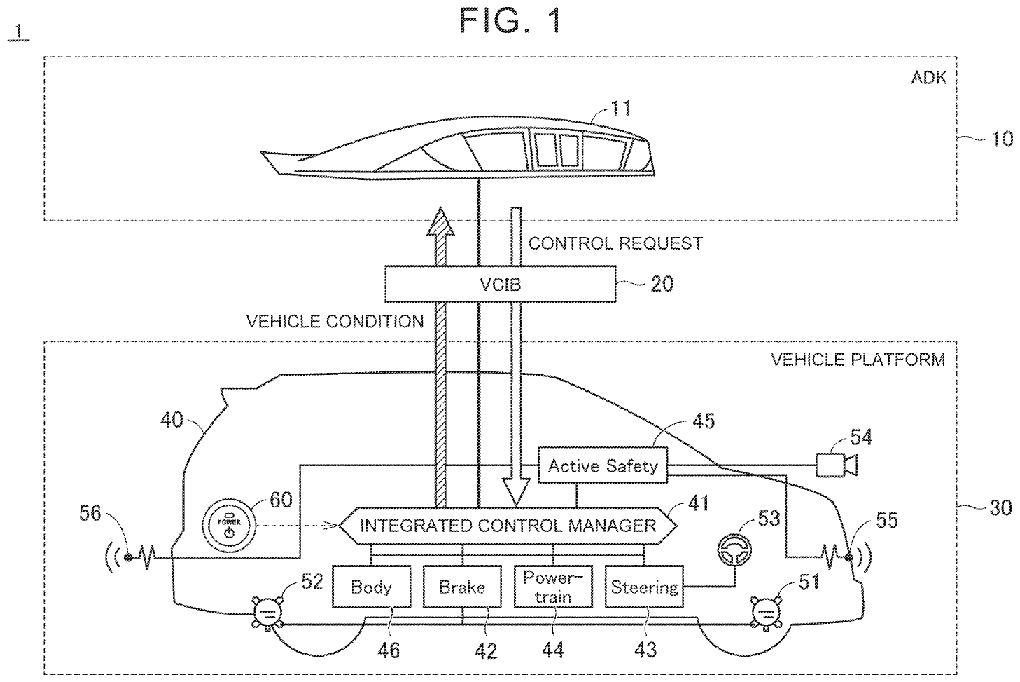

FIG. 1 is a diagram showing an outline of a vehicle according to an embodiment of this disclosure. The vehicle 1 is configured to be capable of highly automated driving (for example, automated driving classified as so-called automated driving level 4 or 5) in which the main driver is a system. In this example, a situation is assumed in which the vehicle 1 is used for an autonomous driving-related mobility service such as a service for transporting passengers.

The vehicle 1 includes an Autonomous Driving Kit (ADK) 10, a Vehicle Control Interface Box (VCIB) 20, and a Vehicle Platform (VP) 30. ADK 10 can be attached to or removed from VP 30 (such as on the rooftop of VP 30). The ADK 10 and the VP 30 are connected to be able to communicate with each other via the VCIB 20 in accordance with a communication standard such as Controller Area Network (CAN).

The ADK 10 includes an Autonomous Driving System (ADS) 11 for automatically driving the vehicle 1. The ADK 10 (ADS 11) creates a travel plan for the vehicle 1. The ADK 10 outputs various commands (control requests) for driving the vehicle 1 according to the travel plan to the VP 30 according to an Application Program Interface (API) defined for each control request. Further, the ADK 10 receives various signals indicating the vehicle status (the status of the VP 30) from the VP 30 according to the API defined for each signal. The ADK 10 then reflects the vehicle condition in the travel plan.

The VCIB 20 receives various control requests from the ADK 10 and outputs vehicle status to the ADK 10 by executing a predetermined API defined for each signal. When the VCIB 20 receives a control request from the ADK 10, it outputs a control command corresponding to the control request to the system corresponding to the control command via the integrated control manager 41. Further, the VCIB 20 acquires various information on the VP 30 from various systems via the integrated control manager 41, and outputs the various information on the VP 30 to the ADK 10 as the vehicle status.

When the ADK 10 is attached, the VP 30 can execute automatic driving control in an automatic driving mode in accordance with a control request from the ADK 10. Note that when the ADK 10 is removed, the VP 30 executes travel control in manual operation mode.

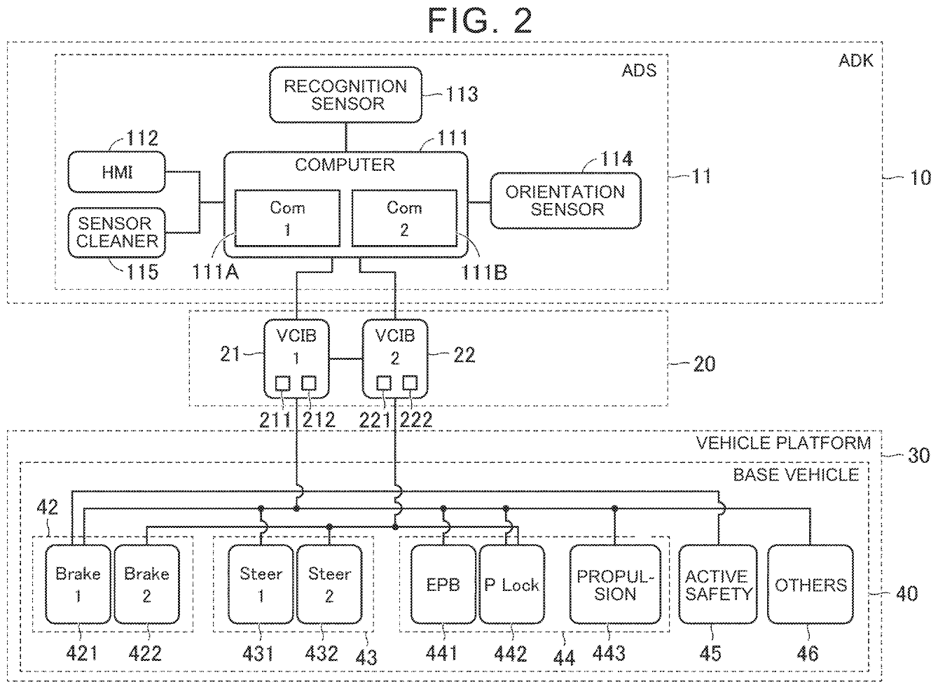

VP 30 includes a base vehicle 40. The base vehicle 40 executes various vehicle controls in accordance with control requests from the ADK 10. The base vehicle 40 includes, for example, an integrated control manager 41, a brake system 42, a steering system 43, a power train system 44, an active safety system 45, other systems 46 (see FIG. 2), wheel speed sensors 51, 52, a pinion angle sensor 53, a camera 54, radar sensors 55, 56, and a power switch 60.

The integrated control manager 41 includes a processor and a memory, and integrates and controls each of the above-mentioned systems related to the operation of the vehicle 1.

The brake system 42 controls a braking device provided on each wheel of the base vehicle 40. Wheel speed sensors 51 and 52 are connected to the brake system 42. Wheel speed sensors 51 and 52 detect the rotation speeds of the front wheels and rear wheels of the base vehicle 40, respectively, and output them to the brake system 42. The brake system 42 outputs the rotational speed of each wheel to the VCIB 20 as one of the information included in the vehicle status. The integrated control manager 41 calculates the speed (vehicle speed) of the vehicle 1 based on the rotational speed of each wheel. Further, the brake system 42 generates a braking command for the braking device in accordance with a predetermined control request output from the ADK 10 via the VCIB 20 and the integrated control manager 41. The brake system 42 controls a braking device using the generated braking command.

The steering system 43 controls the steering angle of the steered wheels of the vehicle 1 using a steering device. A pinion angle sensor 53 is connected to the steering system 43. The pinion angle sensor 53 detects the rotation angle (pinion angle) of a pinion gear connected to the rotation shaft of the actuator and outputs it to the steering system 43. The steering system 43 outputs the pinion angle to the VCIB 20 as one of the information included in the vehicle state. Further, the steering system 43 generates a steering command for the steering device in accordance with a predetermined control request output from the ADK 10 via the VCIB 20 and the integrated control manager 41. The steering system 43 controls the steering device using the generated steering command.

The power train system 44 includes an Electric Parking Brake (EPB) system 441 provided on at least one of a plurality of wheels, a parking lock (P-Lock) system 442 provided on the transmission of the vehicle 1, The propulsion system 443 includes a shift device configured to be able to select a shift position.

The active safety system 45 uses the camera 54/radar sensors 55 and 56 to detect obstacles in front or behind (pedestrians, bicycles, parked vehicles, utility poles, etc.). The active safety system 45 determines whether there is a possibility that the vehicle 1 will collide with an obstacle based on the distance between the vehicle 1 and the obstacle and the direction of movement of the vehicle 1. When the active safety system 45 determines that there is a possibility of a collision, it outputs a braking command to the brake system 42 via the integrated control manager 41 so that the braking force is increased.

Power switch 60 accepts a user's operation to select a power source position of vehicle 1. The power positions include an ignition off (IG-OFF) position, an accessory (ACC) position, an ignition on (IG-ON) position, a starting position, and a Ready ON position.

The IG-OFF position corresponds to a power-off state of the vehicle 1. In the IG-OFF position, power supply to each device mounted on the vehicle 1 is cut off. In the ACC position, power is supplied to accessory devices such as air conditioners and audio equipment. In the IG-ON position, power is supplied not only to accessory devices but also to systems necessary for running the vehicle 1. When the activation position is selected, the VP 30 is activated so as to make the vehicle 1 ready for travel. After the VP 30 is started, an initial diagnosis (initial check) for the VP 30 is performed. The initial diagnosis is a diagnosis to confirm that each system within the VP 30 is normal. When it is confirmed that the VP 30 is normal as a result of the initial diagnosis, it transitions from the startup position to the Ready ON position.

FIG. 2 is a diagram showing the configurations of the ADK 10, VCIB 20, and VP 30 in more detail. As shown in FIG. 2, the ADK 10 (ADS 11) includes a computer 111, a Human Machine Interface (HMI) 112, a recognition sensor 113, an orientation sensor 114, and a sensor cleaner 115.

The computer 111 uses various sensors to acquire the environment of the vehicle 1 as well as the attitude, behavior, and position of the vehicle 1 during automatic operation of the vehicle 1, acquires the vehicle status from the VP 30 via the VCIB 20 to control the vehicle, and sets the next action (acceleration, deceleration, turn, etc.) after 1. Then, the computer 111 outputs various commands to the VCIB 20 for realizing the next operation. Computer 111 includes communication modules 111A and 111B.

The HMI 112 presents information to the user and accepts user operations during automatic operation, operation requiring user operation, transition between automatic operation and manual operation, and the like.

The recognition sensor 113 is a sensor for recognizing the environment of the vehicle 1. The recognition sensor 113 includes, for example, at least one of Laser Imaging Detection and Ranging (LIDAR), a millimeter wave radar, and a camera.

The orientation sensor 114 is a sensor for detecting the attitude, behavior, and position of the vehicle 1. The orientation sensor 114 includes, for example, an Inertial Measurement Unit (IMU) and a Global Positioning System (GPS). The sensor cleaner 115 is configured to remove dirt that adheres to the various sensors (camera lens, laser beam irradiation unit, etc.) while the vehicle 1 is running using a cleaning liquid, a wiper, or the like.

VCIB 20 includes a main VCIB 21 and a sub VCIB 22. VCIB 21 includes a processor 211 and memory 212. VCIB22 includes a processor 221 and a memory 222. Each of the memories 212 and 222 includes a Read Only Memory (ROM) and a Random Access Memory (RAM), and stores a program including a predetermined API defined for each signal. Each of the processors 221, 221 includes a central processing unit (CPU), etc., and performs an interface between the ADK 10 and the VP 30 by executing the above program.

The VCIB 21 and the communication module 111A are connected to be able to communicate with each other. The VCIB 22 and the communication module 111B are connected to be able to communicate with each other. Further, VCIB 21 and VCIB 22 are connected to be able to communicate with each other. Each of VCIBs 21 and 22 relays control requests and vehicle information between ADK 10 and VP 30. Specifically, the VCIB 21 generates a control command from a control request from the ADK 10 using the API. Then, the VCIB 21 outputs the generated control command to a corresponding system among the plurality of systems included in the VP 30. Further, the VCIB 21 uses the API to generate information indicating the vehicle status from the vehicle information from each system of the VP 30. The VCIB 21 outputs the generated information indicating the vehicle state to the ADK 10. The same applies to VCIB 22.

The EPB system 441 controls the EPB according to a control request output from the ADK 10 via the VCIB 21. The EPB is provided separately from a braking device (such as a disc brake system) and fixes the wheels by operating an actuator. P-Lock system 442 controls P-Lock devices according to control requests output from ADK 10 via VCIB 21. The P-Lock system 442 operates the P-Lock device when the control request includes a control request to change the shift position to the parking position (P range), and deactivates the P-Lock device when the control request includes a control request to change the shift position to a position other than the parking position. The P-Lock device locks the rotation of the output shaft of the transmission and locks the wheels.

The propulsion system 443 switches the shift position of a shift device (not shown) and controls the driving force from a drive source (motor generator, engine, etc.) according to a control request output from the ADK 10 via the VCIB 21. or In addition to the parking position, the shift positions include, for example, a neutral position (N range), a forward travel position (D range), a reverse travel position (R range), and a brake position (B range).

Active safety system 45 is communicatively connected to brake system 421. As described above, the active safety system 45 detects an obstacle in front using the camera 54 and/or the radar sensor 55, and when it is determined that there is a possibility of a collision outputs a braking command to the brake system 421 so that the braking force is increased. Other systems 46 include body systems, air conditioners, audio equipment, and the like. The body system controls parts such as a direction indicator, a horn, and a wiper according to control requests from the ADK 10.

In the vehicle 1, automatic driving is performed, for example, when the automatic driving mode is selected by a user's operation on the HMI 112. As described above, during automatic driving, the ADK 10 first creates a travel plan. Examples of travel plans include a plan to continue driving straight, a plan to turn left/right at a predetermined intersection along a predetermined travel route, a plan to change the driving lane, and the like. The ADK 10 calculates control physical quantities (acceleration, deceleration, tire turning angle, etc.) necessary for the vehicle 1 to operate according to the created travel plan. The ADK 10 divides the physical quantity for each API execution cycle. The ADK 10 uses the API to output a control request representing the divided physical quantities to the VCIB 20. Furthermore, the ADK 10 acquires the vehicle status (the actual moving direction of the vehicle 1, the immobilization status of the vehicle, etc.) from the VP 30, and recreates a travel plan that reflects the acquired vehicle status. In this way, ADK 10 enables automatic driving of vehicle 1.

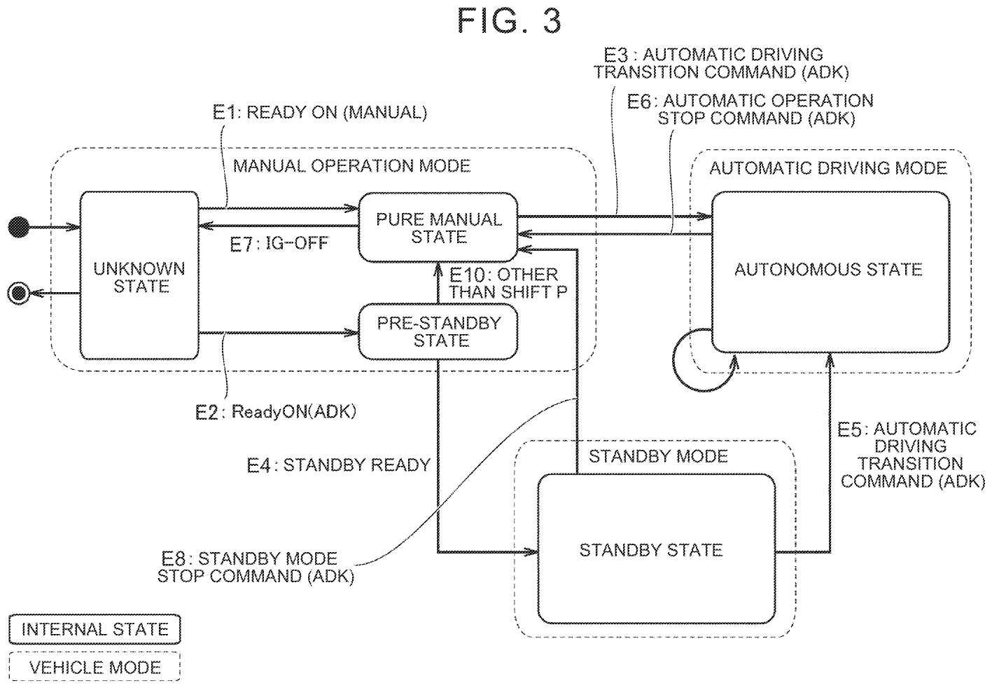

FIG. 3 is a state transition diagram for explaining vehicle modes in this embodiment. VCIB 20 has a standby mode in addition to manual and automatic modes of operation. Further, the manual operation mode includes an Unknown state, a Pure Manual state, and a Pre Stand by state.

The VCIB 20 transits to the pure manual state on the condition that it receives a Ready ON command manually operated by the user in the unknown state (see E1). In the pure manual state, the integrated control manager 41 (or other ECU) performs initial diagnosis.

After the initial diagnosis is performed, the VCIB 20 transitions to the automatic driving mode (autonomous state) on the condition that it receives an automatic driving transition command from the ADK 10 in the pure manual state (see E3). In the automatic driving mode, automatic driving is realized by the integrated control manager 41 controlling the VP 30 according to requests from the ADK 10.

In the automatic driving mode, the VCIB 20 transitions to the pure manual state on the condition that it receives an automatic driving stop command from the ADK 10 (see E6).

On the other hand, on the condition that the Ready ON command is received from the ADK 10 in the unknown state, the VCIB 20 transitions to the pre-standby state (see E2). Even in the pre-standby state, the integrated control manager 41 (or other ECU) performs initial diagnosis. The VCIB 20 changes from manual operation mode (pre-standby state) to standby mode (standby state) on the condition that the conditions for transitioning to standby mode (including, for example, the condition that initial diagnosis has been performed/currently being performed) are satisfied (see E4). In the pre-standby state, a manual operation other than the manual operation to change the shift position to the P range (for example, a predetermined operation to move the vehicle 1, specifically, an operation to change the shift position to the D, R, B range) is received. Under this condition, the VCIB 20 transitions to the pure manual state (see E10).

In this embodiment, the driver's driving intention is detected when a manual operation other than the manual operation to change the shift position to the P range is accepted. However, the driver's driving intention is not limited to this, and the driver's driving intention can be detected by accepting the operation of an operation part for manual driving (for example, an accelerator pedal, a brake pedal, a steering wheel, a parking brake). Alternatively, the detection may be performed by detecting that the vehicle speed has become other than 0.

Further, in this embodiment, the transition to the pure manual state is made on the condition that the driving intention is detected. However, the condition for transitioning to the pure manual state may be, for example, that the transition to standby mode has not occurred even after a predetermined period of time (for example, 8 seconds) has passed since transitioning to the pre-standby state, or it may be an AND condition between this condition and the condition that a driving intention has been detected.

In standby mode, manual operations accepted by VP 30 are suppressed. More specifically, the integrated control manager 41 (which may be an ECU within the propulsion system 443) does not accept a shift operation for the shift device of the propulsion system 443 (switching operation to a shift position other than the P range). Further, the integrated control manager 41 does not accept an accelerator operation (accelerator pedal depression operation). Further, the integrated control manager 41 (which may be an ECU within the EPB system 441) does not accept the EPB release operation of the EPB system 441.

In the standby mode, upon receiving an automatic operation transition command from the ADK 10 and on condition that the shift range is P range, the VCIB 20 transitions to the automatic operation mode (autonomous state) (see E5). In the standby mode, upon receiving an automatic operation transition command from the ADK 10 and on the condition that the shift range is not the P range, the VCIB 20 transitions to an error state.

On the condition that the standby mode stop command is received from the ADK 10 in the automatic operation mode, the VCIB 20 transitions to the manual operation mode (pure manual state) (see E8).

In the pure manual state, on the condition that the IG-OFF operation (typically, the OFF operation of the power switch 60) is performed, the VCIB 20 transitions to the unknown state (see E7).

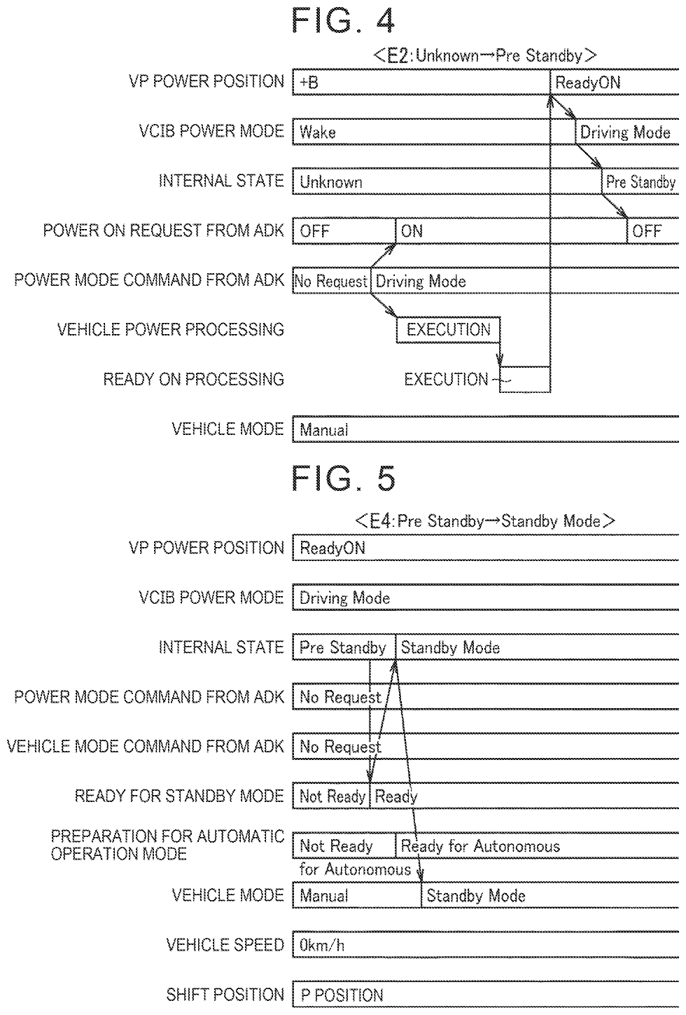

FIG. 4 is a time chart for explaining the transition from the unknown state of the manual operation mode to the pre-standby state (see E2). From top to bottom, FIG. 4 shows the power supply position of the VP 30, electric power mode of the VCIB 20, an internal state, a power ON request from the ADK 10, an electric power mode command from the ADK 10, vehicle power supply processing in the VCIB 20, the Ready ON process in the VP 30 (vehicle 1), and the vehicle mode. Power modes include wake mode and driving mode. The wake mode is a mode in which the VCIB 20 is activated by power supplied from the auxiliary battery of the VP 30. The driving mode is a mode corresponding to the Ready ON state, in which the VCIB 20 and all ECUs are activated, and power is supplied to each system from the high voltage battery.

In the unknown state, the ADK 10 outputs a transition command from the power mode to the driving mode. Then, in the VCIB 20, the power ON request from the ADK 10 is turned on, vehicle power processing is executed, and the Ready ON processing is executed in the VP 30. As a result, the power position of the VP 30 transitions to the Ready ON position. Further, the power mode of the VCIB 20 transitions from wake mode to driving mode, the internal state transitions from an unknown state to a pre-standby state, and the power ON request from the ADK 10 is turned off.

FIG. 5 is a time chart for explaining the transition from the pre-standby state of the manual operation mode to the standby mode (see E4). In addition to the items explained in FIG. 4, FIG. 5 shows a vehicle mode command, standby mode preparation, automatic driving mode preparation, vehicle speed, and shift position from the ADK 10.

When the initial diagnosis is completed in the pre-standby state of the manual operation mode, the internal state transitions from the pre-standby state to the standby state on the condition that standby mode preparation is completed (for example, vehicle speed=0). Along with this, the vehicle mode also transitions from manual operation mode to standby mode.

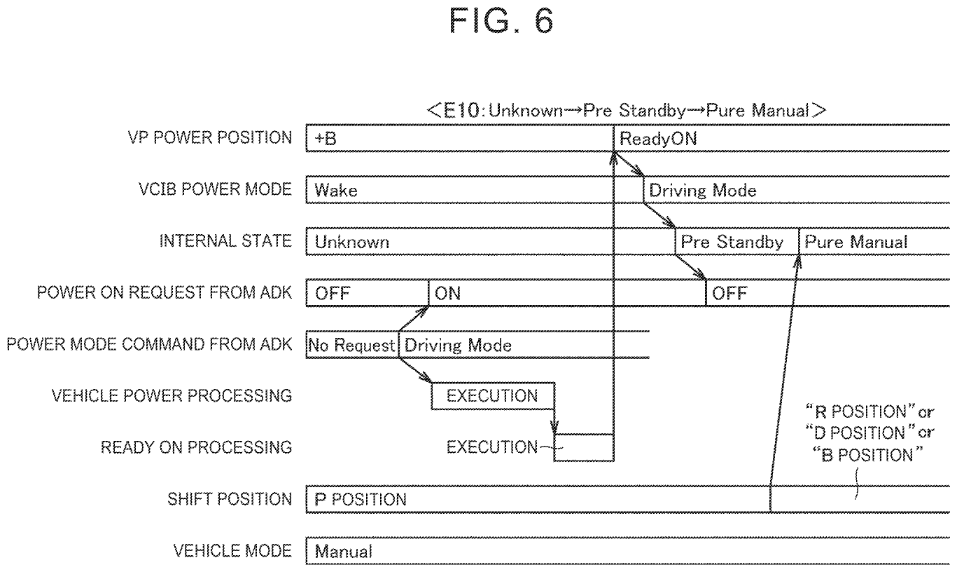

FIG. 6 is a time chart for explaining the transition from the unknown state of the manual mode to the pre-standby state and then to the pure manual state (see E10). After the transition to the pre-standby state as explained in FIG. 4 and before the transition to the standby mode, when the shift position is changed to a range, for example the R, D, or B range other than the P range, the internal state transitions from the pre-standby state to the pure manual state.

Note that the conditions for the mode and state transitions described above may include conditions other than the conditions described above. The embodiments disclosed herein should be considered to be exemplary and not restrictive in all respects. The scope of this disclosure is indicated by the claims rather than the description of the embodiments described above, and it is intended that all changes within the meaning and range equivalent to the claims are included.

What is claimed is:

1. A vehicle control device connected between an automated driving system and a vehicle platform that performs automated driving according to instructions from the automated driving system, the vehicle control device comprising:
a memory that stores a program that includes a predetermined application program interface (API) defined for each signal; and
a processor that interfaces between the automated driving system and the vehicle platform by executing the program, wherein:
the vehicle control device includes a manual driving mode, an automated driving mode, and a standby mode as vehicle modes;
the manual driving mode includes an unknown state, a pure manual state, and a pre-standby state;
the vehicle platform is able to
receive manual driving operations in the manual driving mode,
receive an operation of shifting a shift range to a parking range, among the manual driving operations, in the standby mode, and
receive a driving instruction from the automated driving system in the automated driving mode; and
the processor is configured to
transition to the pure manual state on condition that a startup instruction by a manual operation is received in the unknown state,
transition to the pre-standby state on condition that a startup instruction is received from the automated driving system in the unknown state,
transition to the standby mode on condition that a condition for transitioning to the standby mode is met in the pre-standby state, and
transition to the pure manual state on condition that an intention of a driver to drive is detected in the pre-standby state.

2. The vehicle control device according to claim 1, wherein the processor is configured to:
transition to the automated driving mode on condition that an automated driving transition instruction is received from the automated driving system in the standby mode and that the shift range is the parking range; and
transition to an error state on condition that the automated driving transition instruction is received from the automated driving system in the standby mode and the shift range is not the parking range.

3. The vehicle control device according to claim 1, wherein the processor is configured to transition to the automated driving mode on condition that an automated driving transition instruction is received in the pure manual state.

4. The vehicle control device according to claim 1, wherein the processor is configured to transition to the pure manual state on condition that a standby mode stop instruction is received from the automated driving system in the standby mode.

5. The vehicle control device according to claim 1, wherein the processor is configured to transition to the pure manual state on condition that an automated driving stop instruction is received from the automated driving system in the automated driving mode.
